(19) United States
(12) Patent Application Publication
(10) Pub. No.: US 2020/0019957 A1
(43) Pub. Date: Jan. 16, 2020

(54) GIFT CARD PROMOTION SYSTEM AND METHOD

(71) Applicant: Phillip Scott Bowefield, Bellingham, WA (US)

(72) Inventor: Phillip Scott Bowefield, Bellingham, WA (US)

(21) Appl. No.: 16/510,147

(22) Filed: Jul. 12, 2019

Related U.S. Application Data
(60) Provisional application No. 62/697,267, filed on Jul. 12, 2018.

(51) Int. Cl. G06Q 20/34; G06Q 20/36; G06Q 50/00; G06Q 30/02; G06Q 20/10

(52) U.S. Cl. CPC G06Q 20/342; G06Q 20/367; G06Q 20/102; G06Q 30/0282; G06Q 50/01

(57) ABSTRACT

A gift card promotion system designed for a locally based community network including businesses, purchasers, and customers, whereby a community network platform is provided that is accessible by the users to encourage local growth in the community. The community network platform allows purchasers such as companies or employers to buy gift cards from local businesses and gift them to consumers while also providing the ability of cross selling gift cards between companies as well as enabling referrals of local businesses, incentives, rating systems, registries, task related rewards, and wish lists.

### CROSS-REFERENCE TO RELATED APPLICATIONS

This application is a continuation in part which claims priority to U.S. Provisional Application No. 62/697,267 filed on Jul. 12, 2018, which is incorporated by reference in its entirety.

### FIELD OF THE DISCLOSURE

The present invention relates to the field of gift cards. More particularly, one or more embodiments presented herein relate to a gift card system and method configured for use by small businesses on a community network platform to promote the local economy.

### BACKGROUND

Gift cards are well-known in the art of sales and services as a service for a person (purchaser) to provide a gift to another person (customer) who may not know exactly what they want as a gift. These gift cards are also a good choice for purchasers who may not know the customer well enough to select the just right gift, or where a gift is not easily deliverable or may have options to be selected by the customer. For example, a purchaser may present a gift card to a friend or relative or other individual (i.e. a customer) who then exchanges that gift card or a portion thereof at a business or other establishment for an item of their own choosing. In such a process, the purchaser need not know the specific desires of the customer and may provide a gift card which can be exchanged for any number of items at the discretion of the customer.

Currently, gift cards are a $160 billion dollar per year industry. 12% of this is in digital gift cards, but this percentage is increasing. Traditional gift (physical gift) buying is reducing every year over gift cards due to the flexible nature of the gift card and ease of use. Since 2007, gift cards are the most requested gift. Purchasers like the flexibility that a gift card offers and help to ensure that a customer is not given a gift that the customer will not use or does not appreciate.

Several concerns exist within the field of gift cards. Gift cards are common to large and chain businesses which have the resources available to coordinate a gift card system, however, such gift card systems are often complicated and require resources not available to many small businesses. Gift card systems commonly are complicated and involve multiple coordinated steps including purchasing of the gift card, placing the funds paid for the gift card in trust for later sales, connecting the gift card sales system to the businesses point-of-sale (POS) system, and other concerns that are often cumbersome and time consuming for many small businesses attempting to run and operate a gift card system. To this end, small businesses often coordinate a loyalty system instead of a gift card system.

In a loyalty system the customer is provided a punch card (either physically or digitally). After a certain number of points or total value of purchases, the punch card may be redeemed for a discount amount, retail item, or other benefit that the business has associated with the punch card. In some businesses, a gift card system is utilized which is often literally a card with a dollar value written on it. As the customer makes purchases, the dollar value of the gift card, as recorded in the trust account, is reduced by the amount of the purchase until the full amount of the gift card is depleted. Alternatively, a purchaser may financially contribute to the business in the name of a customer and the business keeps an electronic or manual (paper) record of the contribution. The customer may then make acquisitions from the business and the value of the acquisition is subtracted from the contribution until the contribution is exhausted. It is relatively rare for a small business to have a gift card system as easy to use as that available to large or chain businesses due to the difficulties of integration with the point-of-sale system.

A point of sale (POS) as the term is used herein or point of purchase (POP) includes time and place where a retail or service transaction is completed. At the point of sale, the business calculates the amount owed by the customer and shares this amount with the customer. The business may then prepare an invoice for the customer (which may be a cash register printout) and provides all of the options for the customer to make a payment. It is also the point at which a customer makes a payment to the business in exchange for goods or after provision of a service. This payment may be paid using a gift card in some transactions. After receiving payment, the business may issue a receipt for the transaction, which is usually printed but is increasingly being dispensed with or sent electronically.

To calculate the amount owed by a customer to the business for a sale, the business utilizing a POS system may use various devices such as weighing scales, barcode scanners, and cash registers. To make a payment easier, payment terminals, touch screens, and other hardware and software options are available to the business. The point of sale is (POS) often referred to as the point of service because in some examples these systems are not just a point of sale but also a point of return or customer order. POS terminal software may also include features for additional functionality, such as inventory management, customer relationship management (CRM), financials, or warehousing.

Businesses are increasingly adopting POS systems, and one of the most obvious and compelling reasons is that some examples of a POS system in some examples eliminates the need for price tags. Selling prices are linked to the product code of an item when adding stock, so the business merely needs to scan this product code to process a sale. If there is a price change, this can also be easily done through the inventory window. Other advantages include the ability to implement various types of discounts, a loyalty scheme for customers, and more efficient stock control.

One significant hindrance to the implementation of a gift card system to a small business utilizing a POS system is establishing a data transference or other system connecting the purchase, remaining balance, and record keeping of a gift card system with a POS system designed for calculating the total cost of a sale and transferring funds for the sale from the customer to the business.

Another problem for small businesses, in some examples, is that it is difficult for a purchaser to acquire gift cards through a business especially where manual (hand written gift card, loyalty punch cards, or notebook) methods are used. In such manual systems, the purchaser cannot simply purchase the gift card online and provide the gift card to the customer. Rather, the purchaser must be at the physical location of the business during business hours when staff members of the business are available to provide the gift card in order for the system to be initiated.

Also, an important concern is that typical gift card platforms do not promote local businesses and local service providers. Instead, the gift cards are frequently purchased from credit card providers such as VISA, MASTERCARD, AMERICAN EXPRESS, or the like having prepaid set monetary amounts, or the gift cards are purchased for use at very large national or international chains, such as STARBUCKS, AMAZON, BEST BUY, etc. Gift cards for local businesses are not usually easily obtainable from any location other than that specific business. However, it would be desirable for a local business to be promoted because conducting business with a local business ensures that one's neighbors are directly benefited by purchases, and less of the proceeds are transferred out of the locality.

Thus, there exists a need for a system and method for community-based community network based social marketing platform that leverages leading edge digital gift cards and community network technologies to tap into the intense consumer demand for gift cards and drive sales in a novel format that is easy and engaging for both businesses and consumers to use.

### SUMMARY

The disclosure presented herein relates to an exemplary computer implemented method for promoting local businesses, the method comprising. storing, by a gift card promotion system comprising one or more computing devices, user data for one or more consumers users, comprising a name identifier and one or more gift card preferences, the gift card preferences corresponding to one or more gift cards, presenting a user interface to a purchaser user on a computing device, wherein the user interface comprises at least one list of gift card preferences of the one or more consumer users, requesting, from the purchaser user to purchase a gift card; in response to gift card preferences from the one or more consumer users, using, by the gift card promotion system, the received request, including the amount of the gift card to transfer funds from an account of the purchaser user to an account of the one or more consumer users, collecting, by the gift card promotion system, transactional data, including the amount of the gift card, the business of the gift card, and the location of the business, associating, by the gift card promotion system, the transactional data with the user data of the one or more consumer users, storing, by the gift card promotion system, the transactional data; and notifying, by the gift card promotion system, the gift card has been purchased by the purchaser user for the one or more consumers users available, in response to transaction.

The preceding and following embodiments and descriptions are for illustrative purposes only and are not intended to limit the scope of this disclosure. Other aspects and advantages of this disclosure will become apparent from the following detailed description.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 depicts a schematic diagram of a gift card promotion system according to an illustrative embodiment.

FIG. 2 shows an exemplary block diagram of various components of a user computing device.

FIG. 3 is a flow diagram depicting of a method for purchaser purchasing a gift card for a consumer through gift card promotion system using one or more components included in FIG. 1.

### DETAILED DESCRIPTION

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises”, and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)−(a second number),” this means a range whose limit is the second number. For example, 25 to 100 mm means a range whose lower limit is 25 mm and upper limit is 100 mm.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The present disclosure recognizes the unsolved need for an improved system and method for gift card promotion that utilizes a community-based structure including a community network (marketing/sales) platform that leverages digital gift cards and community network technologies. The gift card promotion system engages consumer demand for gift cards to enable sales in a novel format that in one example is easy and engaging for businesses, purchasers and consumers to use. The gift card promotion system allows for various entities such as local businesses, customers including purchasers and consumers, associations (e.g. sustainable Connections, downtown business partnership or other business, industry or consumer groups, etc.), charities and other local/community/government entities to interact with one another.

This promotion and implementation of the gift card promotion system may be accomplished by providing a custom created community or by being tied to a community network platform such as FACEBOOK, INSTAGRAM, etc. The community provides a visible avenue and means of introduction to purchasers who may not otherwise be aware of certain businesses, or that the businesses have established connection to the system. Such a gift giving system may, advantageously, help to build a community among participating businesses, purchasers, and consumers. Additionally, such communities may then be able to build on themselves to increase interdependence, and the perceived value of the gift cards.

Another benefit of a gift card promotion system, according to one or more illustrative embodiments, is that the purchaser is able to acquire the gift card and make a contribution into a trust account set up for the business. The purchaser may then provide the customer with a gift card, whereby the gift card may be a physical gift card that is mailed to the purchaser or that is available for pickup at the business. Alternatively, the gift card may be a digital gift card having a data link to the trust account such that when the customer acquires an item from the business using the gift card, the value of the item and any other fees are deducted from the trust account.

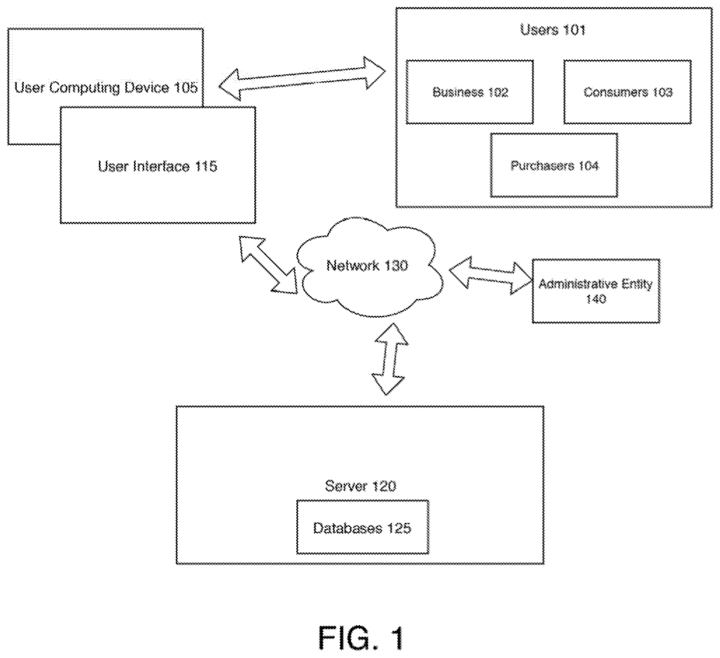

With reference now to FIG. 1, FIG. 1 illustrates a block diagram of one exemplary embodiment of gift card promotion system 100. In one or more non-limiting embodiments, gift card promotion system 100 may be innate, built into, or otherwise integrated into existing social media platforms or systems such as a website, a third party program, Apple™ operating systems (e.g. iOS), Android™, Snapchat™, Instagram™, Facebook™, or any other platform or in other embodiments may be completely manually by a central neighborhood office. Gift card promotion system 100 may include one or more users such as user 101. Users 101 of gift card promotion system 100 may include, without limitation, businesses, such as businesses 102, consumers, such as consumers 103, and purchasers, such as purchasers 104.

Gift card promotion system 100 may include a plurality of consumers 103, purchasers 104, and businesses 102. Consumer 103 may be any individual or other entity utilizing a gift card as a consumer or purchasing a gift card for themselves. Purchaser 104 may be an individual or other entity providing a gift card to consumer 103. Businesses 102 may be an entity where user 101 may utilize the gift card. Business 102 may provide to the consumers retail type merchandise, as well as digital products and/or informational or subscription-based services, or any other type of item or service that is needed. Business 102, as used herein, may also be used to refer to charities and non-profits or to government entities, whether local or community based or national based. In generally, business 102 is any entity that a consumer, such as consumer 103, may interact with for a service or good. In gift card promotion system 100, purchaser 104 is able to arrange for a set monetary amount accessible by consumer 103 to use at business 102 regardless of the type of entity for business 102.

The gift card may be used for one or more goods or services provided by business 102. Examples of goods may include, but are not limited, to electronic appliances or devices, food items, or any other type of goods. Examples of services may include, but are not limited to, a haircut or golf lesson, or any other type of service. Any type of business 102 offering any type of goods or services may be registered of gift card promotion system 100. Further, businesses 102, consumers 103, and purchasers 104, may be located in various geographical locations that are either located apart or are located in proximity to each other. Businesses 102, consumers 103, and purchasers 104, as discussed, may be users such as users 101 of gift card promotion system 100, whereby purchasers 104 may have the capacity to function as a purchaser and as a consumer 103 seeking to receive a gift card for goods or services from businesses 102. Purchaser 104 may also act as business 102 or employee of business 102 providing access to their goods or services through a gift card. In a similar fashion, businesses 102 may also have the capacity to function as a purchaser 104 or consumer 103. Consumer 103 may also have the capacity to function as a business 102 or purchaser 104.

Users 101 of gift card promotion system 100 may access a user interface such as user interface 115 using a user computing device such as user computing device 105. User interface 115 may have a plurality of buttons or icons that are selectable through user interface 115 by user 101 to instruct gift card promotion system 100 to perform particular processes in response to the selections of user 101. Gift card promotion system 100 may be downloadable and installable on user computing devices 105. In some embodiments, gift card promotion system 100 may be preinstalled on user computing devices 105. Further, gift card promotion system 100 may be implemented using a web browser via a browser extension or plugin.

In one embodiment, businesses 102 may provide computing devices, such as user computing devices 105 for use by consumers 103, and purchasers 104. Alternatively, or additionally, consumers 103 and purchasers 104 may have their own user computing devices 105 that include one or more programs for accessing gift card promotion system 100. User computing devices 105 may be in communication with one or more servers, such as server 120, via one or more networks, such as network 130. More description for server 120 and network 130 is included later herein.

Gift card promotion system 100 may also include one or more administrative entities, such as administrative entity 140. While administrative entity 140 is depicted as a single element in FIG. 1 communicating over network 130, administrative entity 140, in one or more non-limiting embodiments, may be distributed over network 130 in any number of physical locations. Administrative entity 140 may manipulate the software and enter commands to server 120 using any number of input devices, such as a keyboard and a mouse. The input/output may be viewed on a display screen to administrative entity 140.

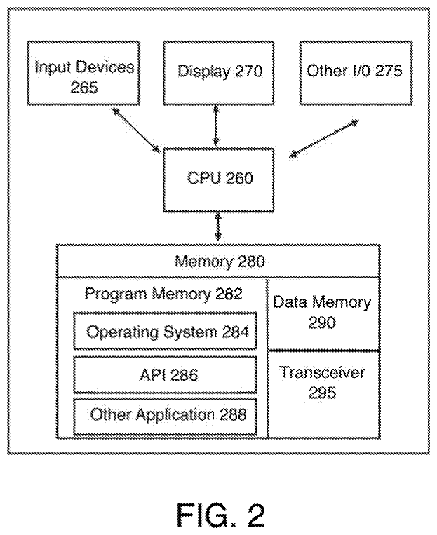

Turning to FIG. 2, FIG. 2 is a block diagram showing various components of user computing device 105. User computing device 105 may include a housing for containing one or more hardware components that allow access to edit and query biometric authentication system 100. User computing device 105 may include one or more input devices such as input devices 265 that provide input to a CPU (processor) such as CPU 260 of actions related to user 101. Input devices 265 may be implemented as a keyboard, a touchscreen, a mouse, via voice activation, wearable input device, a camera a trackball, a microphone, a fingerprint reader, an infrared port, a controller, a remote control, a fax machine, and combinations thereof.

The actions may be initiated by a hardware controller that interprets the signals received from input device 265 and communicates the information to CPU 260 using a communication protocol. CPU 260 may be a single processing unit or multiple processing units in a device or distributed across multiple devices. CPU 260 may be coupled to other hardware devices, such as one or more memory devices with the use of a bus, such as a PCI bus or SCSI bus. CPU 260 may communicate with a hardware controller for devices, such as for a display 270. Display 270 may be used to display text and graphics. In some examples, display 270 provides graphical and textual visual feedback to a user.

In one or more embodiments, display 270 may include an input device 265 as part of display 270, such as when input device 265 is a touchscreen or is equipped with an eye direction monitoring system. In some implementations, display 270 is separate from input device 265. Examples of display 270 include but are not limited to: an LCD display screen, an LED display screen, a projected, holographic, virtual reality display, or augmented reality display (such as a heads-up display device or a head-mounted device), wearable device electronic glasses, contact lenses capable of computer-generated sensory input and displaying data, and so on. Display 270 may also comprise a touch screen interface operable to detect and receive touch input such as a tap or a swiping gesture. Other I/O devices such as I/O devices 275 may also be coupled to the processor, such as a network card, video card, audio card, USB, FireWire or other external device, camera, printer, speakers, CD-ROM drive, DVD drive, disk drive, or Blu-Ray device. In further non-limiting embodiments, a display may be used as an output device, such as, but not limited to, a computer monitor, a speaker, a television, a smart phone, a fax machine, a printer, or combinations thereof.

CPU 260 may have access to a memory such as memory 280. Memory 280 may include one or more of various hardware devices for volatile and non-volatile storage and may include both read-only and writable memory. For example, memory 280 may comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. Memory 280 may be a non-transitory memory.

Memory 280 may include program memory such as program memory 282 capable of storing programs and software, including an operating system, such as operating system 284. Memory 280 may further include an application programing interface (API), such as API 286, and other computerized programs or application programs such as application programs 288. Memory 280 may also include data memory such as data memory 290 that may include database query results, configuration data, settings, user options, user preferences, or other types of data, which may be provided to program memory 282 or any element of user computing device 105.

User computing device 105 may in some embodiments, be a computing device such as a merchant terminal device, dedicated register device, iPhoneυ, Android-based phone, or Windows-based phone, a tablet, television, desktop computer, laptop computer, gaming system, wearable device electronic glasses, networked router, networked switch, networked, bridge, or any computing device capable of executing instructions with sufficient processor power and memory capacity to perform operations of user computing device 105 while in communication with network 130. User computing device 105 may have location tracking capabilities such as Mobile Location Determination System (MLDS) or Global Positioning System (GPS) whereby they may include one or more satellite radios capable of determining the geographical location of computing device.

User computing device 105 may have a transceiver, such as transceiver 295, to transmit the biometric sample or extracted biometric hash string. Transceiver 295 may have a wired or wireless connection and may comprise a multi-band cellular transceiver to connect to the server 120 over 2G/3G/4G cellular networks. Other embodiments may also utilize Near Field Communication (NFC), Bluetooth, or another method to communicate information.

User computing device 105 may be in communication with one or more servers such as server 120, as illustrated in FIG. 1, via one or more networks such as network 130. Server 120 may be located at a data center or any other location suitable for providing service to network 130 whereby server 120 may be in one central location or in many different locations in multiple arrangements. Server 120 may comprise a database server such as MySQL® or Maria DB® server. Server 120 may have an attached data storage system storing software applications and data. Server 120 may receive requests and coordinates fulfillment of those requests through other servers.

Server 120 may comprise a number of modules, that provide various functions related to user computing device 105 using one or more computing devices. Computing devices may have a similar configuration to user computing device 105. Modules may be in the form of software or computer programs that interact with the operating system of server 120 whereby data may be collected in one or more databases, such as databases 125, and may be processed by one or more processors within server 120 as well as in conjunction with the execution of one or more other computer programs. Software instructions for implementing the detailed functionality of the modules may be written in or natively understand C, C++, Visual Basic, Java, Python, TCL, Perl, Scheme, Ruby, etc.

Databases 125 may have one or more databases for storing data for the profiles of users 101, businesses 102, consumers 103, purchasers 104, as well as any gift cards, transactions, financial information, activity, and communication between users 101. Modules may be configured to receive commands or requests from user computing devices 105, server 120, and any other outside connected devices or components over network 130. Server 120 may comprise systems, subsystems, and modules to support one or more management services for gift card promotion system 100.

Continuing with gift card promotion system 100, user computing devices 105, and server(s) 120 may all be communicatively connected to network 130. In one or more embodiments, network 130 may include a local area network (LAN), such as a company Intranet, a metropolitan area network (MAN), or a wide area network (WAN), such as the Internet or World Wide Web. Network 130 may be a private network or a public network, or a combination thereof. Network 130 may be any type of network known in the art, including telecommunications network, a wireless network (including WI-FI), and a wireline network. Network 130 may include mobile telephone networks utilizing any protocol or protocols used to communicate among mobile digital computing devices (e.g. user computing device 105), such as GSM, GPRS, UMTS, AMPS, TDMA, or CDMA. In some embodiments, different type of data may be transmitted via network 110 via different protocols.

Network 130 may further include a system of terminals, gateways, and routers. Network may employ one or more cellular access technologies including 2nd (2G), 3rd (3G), 4th (4G), 5th (5G), LTE, Global System for Mobil communication (GSM), General Packet Radio Services (GPRS), Enhanced Data GSM Environment (EDGE), and other access technologies that may provide for broader coverage between computing devices and business computing device if for instance they are in a remote location not accessible by other networks.

Users 101 may initially start a session by launching gift card promotion system 100 on user computing devices 105. In other embodiments, users 101 may initially commence a session by going to a predefined website address or domain name. In other embodiments, user computing devices 105 may have gift card promotion system 100 downloaded onto the user computing devices 105 used by users 101.

Server 120 may create one or more locally based community networks, stored on databases 125 whereby users 101 may be associated with a specific geographic location. The term “locally based” used in this disclosure may mean community, city, town, township, municipality, county, state, country, continent, etc. as well as any other community networks. User interface 115 may provide multiple ways to login such as a private login where users 101 may interact with other users 101 in a specific locally based community network and have information presented specifically tailored to them. There may also be a public login whereby users 101 may interact with all other users 101 that are of any geographic distance or location. User interface 115 may provide connection information about users 101, such as names, photos, activities, and interests, and relationship of other users 101 whom are in the location based community network when privately logged whereby this information cannot be accessed when publicly logging on to gift card promotion system 100

Businesses 102 may register a business associated with gift card promotion system 100, such that gift cards for their goods and services may be available to consumers 103 to acquire good and services for themselves or for purchaser 104 to purchase gift cards for consumers 103 with access to gift card promotion system 100. Any user 101, such as purchaser 104 or consumer 103, may also register business 102 associated with gift card promotion system 100, such that gift cards for their goods and services may be available to consumers 103 to acquire good and services for themselves or for purchaser 104 to purchase gift cards for consumers 103 with access to gift card promotion system 100.

In one embodiment, upon initially signing up with gift card promotion system 100, businesses 102 may be prompted to join a locally based network as well as provide information along with a requested password. Information requested from businesses 102 may include the location, services and goods provided, hours, directions, promotional content, contact information, corporate structure. When registering with gift card promotion system 100, businesses 102 may also be able to log into gift card promotion system 100 using login credentials from other social networking platforms, such as, for example, logging in with a Yelp® profile.

User interface 115 may provide information and options for businesses 102 to input relevant information associated with its goods and services, including, without limitation, images related to goods and/or services, available selections, quantity, and/or promotional material that may be viewed by other users 101. In other embodiments, a developer or designer may input a unique business 102 profile into database 125 for connecting with users 101 and receiving gift card orders.

Upon successful authentication of business 102, a business profile page may be generated by server 120 using information stored on databases 125 whereby business profile page may be visible to business 102 and other users 101 when navigating through gift card promotion system 100. If multiple businesses 102 are created or owned by a single user 101, user 101 may be presented with a drop down menu whereby they may select a specific business 102. Next, in one embodiment, server 120 may then receive this request and display business 102 selected by user 101. Business profile pages for business 102 may be modified, written to, or otherwise administered by, their respective owner (user 101 who has verified they are the owner or representative of business 102). Administrative entity 140 may modify or delete a business profile page, for example, as a result of inactivity or inappropriate action on the behalf of business 102 or user 101.

Business profile page may include a details tab for displaying information related to the business 102, such as but not limited to business name, services offered, description, photos, average ratings received from consumers 103, purchasers 104, or other businesses 102, as well as a selectable message button, follow button, share button, and book now button for users 101 to interact with. The follow button may be selected to start following business 102 whereby business 102 may appear on the status feed and favorites list of users 101 that have followed businesses 102. Similarly, a first user 101 can go to a profile page of a second user 101 and select to follow or friend second user 101. User 101 may also be presented with the option to select particular photographs to be uploaded and displayed on the details tab. A business profile page associated with business 102 may include a services & hours tab for displaying information related to the services provided by business 102 as well as the operating working hours for business 102. Server 120 may retrieve associated data with users 101 who have followed business 102, and may provide business 102 with a list of such users for business 102 to view and to be aware which users are interested in their business. In addition to the above, business 102 may be able to provide a list of gift cards available for purchase by users 101.

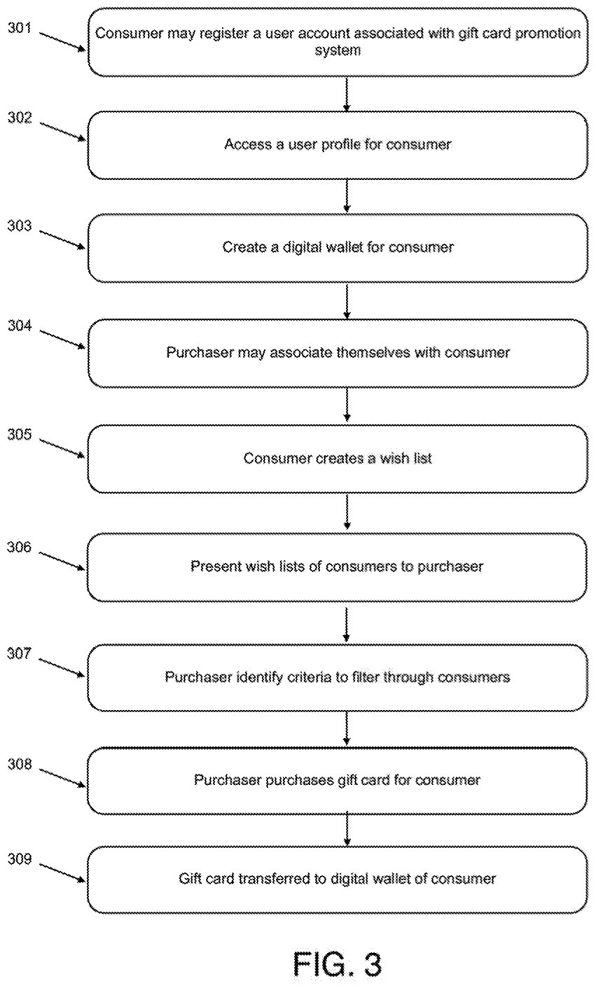

FIG. 3 illustrates flow chart showing an exemplary method involving gift card promotion system 100. In one embodiment, purchaser 104 is able to purchase a gift card for consumer 103 through gift card promotion system 100 involving one or more block components included in FIG. 1, such as, without limitation, user computing device 105, business 102, consumer 103, purchaser 104, server 120, and network 130. Further, one or more exemplary method steps may be performed by gift card promotion system 100, including server 120, user computing devices 105, which may be interconnected via network 130.

At step 301, consumer 103 may register a user account associated with gift card promotion system 100. Consumer 103 may initiate a session over network 130 with user computing device 105. Session may be initially started by consumer 103 launching and running gift card system 100 on user computing device 105 through a manufacturer prescribed process such as downloading gift card promotion application from an application store. Alternatively, or additionally, gift card promotion system 100 may be preinstalled by the manufacturer or service provider on user computing device 105. In some embodiments, consumer 103 may navigate to a specific web address to initiate a session.

At step 302, a user profile for consumer 103 may be accessed. In one embodiment, server 120 may be used to access the user profile. In one embodiment, the user profile may reside in databases 125 on server 120, which may be accessed and referenced using an identifier provided by consumer 103 as part of the registration process or login process such as an account name and password.

When consumer 103 initially registers to become a registered user of the gift card promotion application, consumer 103 may be prompted to provide some personal information along with a requested account name and password, such as, without limitation, his or her name, age (e.g., birth date), gender, interests, contact information, home town, address, preferences of food, favorites businesses, skills, professional organizations, or relationship status. In some embodiments, when registering a user account for consumer 103, gift card promotion system 100 may allow consumer 103 to access and interact with gift card promotion system 100 using login credentials from other social networking platforms. For example, in some embodiments, it may be useful and convenient for users of gift card promotion system 100 to be able to log in using credentials or sign in information from another application, such as Facebook® or Instagram ® or the like. This is advantageous for consumers 103 who do not wish to have to learn or provide multiple login information.

Consumer 103 may be requested to take pictures of themselves whereby server 120 collects and stores pictures of each consumer 103 in databases 125 to display to other users 101 through user interface 115. Pictures may be for identification purposes during navigation of a session and to enhance the authenticity of the process by ensuring that the picture is of the correct, intended consumer 103 when utilizing a gift card at a business 102 and when using the gift card to order goods or services. Consumer 103 may couple, link, or connect with user accounts from social networking websites and internal networks. Examples of social networking websites include but are not limited to Instagram®, Facebook®, LinkedIn®, Snapchat®, and Twitter®. Server 120 may use access tokens or other method as a parameter for searching for a friend list or address book of consumer 103 on a social networking site or other site. Server 120 then may use this friend list information to initialize a contact list database for consumer 103 stored within databases 125.

Consumer 103 may also couple, link, or connect with loyalty programs of other businesses so as to also be rewarded with loyalty program points, a membership upgrade, access to premium services or benefits, a credit towards future services, a gift card, voucher, discount, or coupon.

Consumer 103 may opt-in for various gift card promotion system 100 notifications to be transmitted by server 120. Consumer 103 may opt-in to allow gift card promotion system 100 to notify consumer 103 when certain events occur such as events related to businesses 102 or purchasers 104. In other non-limiting embodiments consumer 103 may establish one or more different profiles whereby the different profiles may individually have different digital wallets. For instance, if a father wants to have a digital wallet for his son, he could establish a second profile for his son whereby his son may have his own digital wallet.

At step 303, upon successful authentication of consumer 101, server 120 may create a digital wallet for consumer whereby server 120 associates a value of any gift card for a business 102 gifted or received by a purchaser 104 or purchased directly by consumer 103, or any other method of reception, with the digital wallet of consumer. Gift card promotion system 100 enables a financial transaction with the digital wallet through methods known by those of ordinary skill in the art such as but not limited to a digital bar code, digital QR, NPC technologies, and Bluetooth technologies. The value of the gift cards associated with the digital wallet and the corresponding financial transactions conducted with each of the gift cards are stored in databases 125.

Gift card promotion system 100 may allow consumer 103 to scan a physical gift card they have acquired or already owned with user computing device 105 using a camera to capture an image or video frames of the gift card. The monetary value associated with the scanned gift card is retrieved by server 120 and stored in the digital wallet in databases 125. In one embodiment, consumer 103 may scan the bar code on a gift card with user computing device 105. Server 120 may then receive a digital image of the gift card sent by consumer 103. Digital image of the gift card includes a machine-readable symbol such as a bar code. Consumer 103 may take a picture or a video of the bar code of the gift card with user computing device 105. Server 120 processes the captured image of the gift card to extract the issuer name (such as a bank name), unique account number, serial number, expiration date, using any algorithms known by those or ordinary skill in the art. The value of the scanned gift card is determined by communicating with an issuer of the gift card. The value on the scanned gift card is uploaded into the digital wallet of consumer 103 and presented to consumer 103 through user interface 115. Consumer 103 may then use the gift card on user computing device 105 to purchase goods or services at business 102.

In other non-limiting embodiments, server 120 may also receive an email from the issuer of the gift card for consumer 103. For example, consumer 103 purchases a gift card online and receives the gift card via email. Consumer 103 may then copy email and input email through gift card promotion system or forward email. Server 120 receives the email in electronic form and the value of the scanned gift card is determined by communicating with an issuer of the gift card. The value on the scanned gift card is uploaded into the digital wallet of consumer 103 and presented to consumer 103 through user interface 115. Consumer 103 may then use the gift card on user computing device 105 to purchase goods or services at business 102. In some embodiments, consumer 103 may manually enter the gift card through user interface 115.

Server 120 may communicate with business 102, issuer of the gift card, or a third party via network 130 to obtain the current or latest balance or value of the gift card. Server 120 then associates the retrieved value of the gift card with a gift card balance in the digital wallet of consumer 103. For example, the digital wallet of consumer 103 comprises a dining balance account of consumer 103. As such, if the balance of the scanned gift card is ten dollars, the balance of the dinning balance account of consumer 103 will reflect a ten dollar credit from the scanned gift card. The dining balance account of consumer 103 and the corresponding gift card are debited when consumer 103 performs a financial transaction (e.g. purchase a meal with the gift card).

In another embodiment, gift cards in the digital wallet can be replenished by transferring money to the issuer (or a third party) (i.e. business 102) associated with the gift card. For example, consumer 103 may transfer money from his personal checking account to the financial account associated with the issuer of the gift card. Gift card promotion system 100 may communicate with at least one third-party payment facilitator over network 130. Payment facilitators may include credit or debit card providers and billing service providers that perform invoicing and related functions. Consumer 103 may input their credit card or debit card information for a credit card or debit card using any card known in the art, including, without limitation an ATM card, a VISA®, MasterCard®, Discover®, or American Express® card in a credit card input field, or can alternatively use PayPal® Squarepay® or the like. Once the transaction has been approved by the third-party payment facilitator funds are deducted from the personal account of consumer 103 and added to the financial account associated with the issuer of the gift card. If there are insufficient funds, a rejection may occur wherein the rejection transaction is logged in databases 125 and consumer 103 may be presented with the rejection notice through user interface wherein they may attempt another transaction.

A plurality of gift cards from the same business 102 or issuer may be combined into a single gift card for convenience purposes to consumer. For instance, if one gift card only has a balance of 10 dollars while another gift card has a balance of 7 dollars, server 120 combines the total value from all the gift cards for a total of 17 dollars and stores them in a single financial account associated with the business 102 in the digital wallet for consumer 103. This allows consumer 103 to perform a financial transaction with the single account without having to keep track of the multiple gift cards from the same business 102 or issuer.

Upon successful authentication of consumer 101, a user profile page may be generated whereby user profile page may be visible to consumer 101 and other users 101 on gift card promotion system 100. User profile pages may be modified, deleted, written to, or otherwise administered by, their respective consumer 103. Display to consumer 103 through user interface 115 may comprise a number of different subpages viewable or accessible through user interface 115 by selecting one or more tabs or navigational buttons.

User profile page may display the user profile page of designated consumer 103 and comprise a number of different subpages viewable or accessible by selecting one or more navigational buttons. User profile page may include a details tab for displaying information related to consumer 103 such as but not limited to name, user name, address, description, and one more photos. Consumer 103 may also be presented with option to select particular photographs to be collected by server 120 whereby server 120 then displays these photographs on the details tab. User profile page may include a wish list tab for displaying businesses 102 that consumers 103 has favorited through gift card promotion system and information related to businesses 102 such as address, pictures, and number of gift cards given to consumer through gift card promotion system 100. User profile page may include a friend's tab for displaying to second users 101 who have made a mutual connection through gift card promotion system 100 with consumer 103.

User profile page may include a selectable button to add second users 101 as friends. After selecting the add friend button, user interface 115 may display a search window whereby consumer 103 may search for a second user 101. A search request having a character string may be entered into the search window by consumer 103 whereby server 120 may receive this request and then display one or more users 101, identified using their name or other meta data related to consumer 103. If consumer 103 to add second user 101 to their list of friends, consumer 103 selects the option to request to add second user 101. In other non-limiting embodiments consumer 103 may select this option by selecting second user 101 when navigating through gift card promotion system 100. For instance, if a post by second user 101 is displayed to user 101 on a business profile page. Purchasers 104 and businesses 102 may search for and add friends in a similar fashion to consumer 103.

Search tab of user profile page may display a search window whereby consumer 103 may search for a user such a specific consumer 103, purchaser 104, or a business 102 using a name or category. A search request having a character string may be entered into the search window by user 101 whereby one or more second users 101 may be identified using name, location, products available, type of services provided, or other meta data related to second user 101. Further, the closest second users 101 matching the search request may be provided on a drop down list presented to user 101 whereby user 101 may select second user 101 and be displayed their respective profile page. For example, if user 101 wants to locate a nearby burger restaurant to order food, consumer 103 may type “burger restaurant” into the search window. Server 120 may access databases 125 and return a list of burger restaurants

In another example, if consumer 103 wants to locate an automobile shop named “Joe's” user may type “Joe's” with a search request. Accordingly, a list of automobile shops named “Joe's” may be provided to consumer 103 in response to their search. In a further example, if consumer 103 wants to locate another user named “Tristan's”, user 101 may type in “Tristan's” into the search window. A list of “Tristan's” may be provided to consumer 103 in response to their search. Businesses 102 may be listed based on similarity to consumers 103 search entry but also may be listed based on rating by users 101 or how complete their business profile page. For example, server 120 or some other agent may determine a quality score from one or more weighted amounts of calculated profile attributes such as photos, address, location, name. The sum of all the weighted amounts is then normalized to determine the quality score of business 102.

Consumer 103 may input additional text into the search window or changes to the existing search request through user interface to receive an updated list of users 101 based on the newly entered text. Consumer 103 may also be presented with the ability to adjust and select filtering parameters such as specific location, wish list selections, categories, price, distance from consumer 103, already visited businesses 110, and/or business hours. Further, in some embodiments, these parameters as well as others may be automatically factored in when a search request is conducted such as consumer 103 searching for automobile shops whereby a list of automobile shop are displayed that are in closest proximity to consumer 103.

In a similar manner to consumer 103 and business 102, purchaser 104 may register to become a registered user 101 of the gift card promotion system 100 whereby purchaser 104 may be prompted to provide some personal information along with a requested account name and password, such as, without limitation, his or her name, age (e.g., birth date), gender, interests, contact information, home town, address, preferences of food, favorites businesses, skills, professional organizations, or relationship status. It should be understood that purchaser 104 may also be a business 102 or a consumer 103 as well as vice-versa.

Upon successful authentication of purchaser 104, a user profile page may be generated whereby user profile page may be visible to purchaser 104 and other users 101 on gift card promotion system 100. Display to purchaser 104 through user interface 115 may comprise a number of different subpages viewable or accessible through user interface 115 by selecting one or more tabs or navigational buttons.

Purchaser 104 profile page may include a selectable button to add consumers 103 or to other wise associate consumers 103 with purchaser 104. Purchaser 104 may wish to do this to associate with a consumer 103 using gift promotion system 100 wherein purchaser 104 may provide funds for consumer's 103 digital wallet and provide other incentives. For example, purchaser 104 may be an employer who wishes to send gift cards to consumers 103 such as employees of their company for advertising or as a reward for their services.

At step 304, purchaser 104 may associate with one or more consumers 103. After selecting a navigational button to add a consumer 103, user interface 115 may display a search window whereby purchaser 104 may search for a consumer 103 from a pool of consumers 103. A search request having a character string may be entered into the search window by purchaser 104 whereby server 120 may receive this request and then display one or more consumers 103, identified using their name or other metadata related to consumer 103. If purchaser 104 wants to add a consumer 103 to a list of consumers 103, purchaser 104 selects the option to request consumer 103 to the list associated with purchaser 104.

In response to the request by purchaser 104, server 120 generates a consumer request and notifies consumer 103 of the request by purchaser 104 and displays the request on consumer's 103 notification tab of his or her user profile on user's computing device, such as user computing device 105. If consumer 103 receiving incoming request responds to the notification, consumer 103 is presented with an accept request decision and a decline request decision. Accepting request initiates an action whereby server 120 stores this action on databases 125 whereby server 120 may present consumer 103 on purchaser's 104 list or pool of consumers 103. If consumer 103 receiving the request declines the request, the request is removed from the notifications tab. Consumer 103 receiving the request may optionally stop future requests being received from purchaser 104 whereby server 120 prevents all future requests from purchaser 104 to consumer 103.

Consumer 103 may also be added to list or pool of consumers associated with purchaser 104 by any method known by those of ordinary skill in the art such as verification through a scannable code, such as a QR code. In this method, consumer 103 may display a QR code presented through user interface 115 to purchaser 104 whereby purchaser 104 may scan QR code utilizing camera on user computing device 105, where consumer 103 may be automatically added to a list of consumers associated with purchaser 104. Having a list of consumers associated with purchaser 104 may make it more convenient for purchaser 104 to purchase and provide gift cards to certain individuals, as that information may be stored with data associated with purchaser 104. Lists may also be added by connecting to a third party network or database such as a work enterprise wherein purchasers 104 that have linked their gift card promotion system 100 account to the work enterprise of a purchaser may automatically appear on a list of consumers 103 that may be presented to purchaser 104. In further embodiments purchaser 104 may send out a communication such as an email to consumer 103 wherein when consumer 103 selects a selectable link they are registered to purchaser's 104 list of consumers 103.

At step 305, user interface 115 enables consumer 103 to search and select a business 102 to identify a list of businesses 102 that they are interested in receiving gift cards from given by a purchaser 104, called a “wish list.” The wish list allows gift buying to be easier to purchaser and ensures a gift which is desired by the consumer 103. In other embodiments, the wish list is generated in various other ways. For example, a wish list may be generated manually by a user 101 who knows the gift recipient or even if they do not know the gift recipient, possesses certain information about the gift recipient. Alternatively, the wish list may be generated automatically based upon information known about consumer 103 based on preferences or location.

At step 306, purchaser 104 may be presented with this information when viewing user profile page of consumer 103 or when selecting consumer's 103 name on the list of consumers 103 that have been associated with purchaser 104 from user profile page of purchaser 104. Purchaser 104 may select a gift card at a price from the wish list associated with consumer 103. In some embodiments, the wish list is one that has been generated by consumer 103 as previously discussed. In some embodiments, purchaser 104 instead may select a gift card from among gift cards automatically recommended for consumer 103 based on one or more preferences of consumer 103 or locations visited by consumer 103 while utilizing gift card promotion system 100.

At step 307, upon viewing consumer 103 list of purchaser 104, purchaser 104 may optionally identify the criteria that they wish to use to filter through consumers. Some potential criteria may be name, title, age, or price range or category of gift card or the specific business 102 or reseller user 101. Purchaser 104 then may either locate the desired consumer 103 that they desire to purchase a gift card for or purchaser 104 may select multiple consumers 103. Upon locating consumer 103, purchaser 104 may optionally identify the criteria that they wish to use to filter the gift cards on the wish list. Some potential criteria may be price range or category of the gift card as well as the specific business 102 or reseller user 101. User interface 115 then may display the appropriate wish list items for the desired consumer 103. Purchaser 104 may then select a gift card of interest to be shown more detailed information. At this point, the gift purchaser can optionally choose one of two paths. They may either choose the business and be re-directed to a business 102 profile page or payment screen for business 102 or choose an alternate business and be re-directed to the alternate business 102 profile page or payment screen.

At step 308, purchaser 104 may purchase gift card whereby server 120 transfers money from purchaser's 104 personal checking account or some other payment account to the financial account associated with the issuer of the gift card that is on the wish list of consumer 103. Gift card promotion system 100 may then communicate with at least one third-party payment facilitator over network 130. Purchaser 104 may input their credit card or debit card information for a credit card or debit card using any card known in the art, including, without limitation an ATM card, a VISA®, MasterCard®, Discover®, or American Express® card in a credit card input field, or can alternatively use PayPal® Squarepay® or the like.

At step 309, once the transaction has been approved by the third-party payment facilitator funds are deducted from purchaser 103 and added to the financial account associated with the issuer of the gift card and the gift card or amount is deposited to the digital wallet of consumer 103. Consumer 103 is notified of this transfer of the gift that may be available in his or her in digital wallet or the funds may be added to a preexisting gift card in his or her digital wallet. If there are insufficient funds, a rejection may occur wherein the rejection transaction is logged in databases and consumer 103 may be presented with the rejection notice through user interface 115 whereby they may attempt another transaction.

In some embodiments, after consumer 103 has been added to a list of purchaser 104, a reloadable gift card with the purchaser's 104 name, as well as decorations, signs, patterns, or other indicia chosen by purchaser 104 or associated with purchaser 104 may then be sent to consumer 103 via physical mail. Before delivery, user interface 115 may prompt consumer 103 to provide their shipping information.

The last four digits of the gift card being sent to consumer 103 are retained and stored as a unique identifier in databases 125. Consumer 103 may be sent a message through application or by email or text a predetermined amount of days after the gift card was generated or days after the gift card was mailed. This email asks consumer 103 whether they have received the card. Consumer 103 may log in to gift card promotion system 100 and verify that they have received the gift card by a method such as entering the last four digits of the gift card number. Server 120 receives the last four digits as entered by consumer 103 and proceeds to verify the last four digits by matching the numbers entered by consumer to that of the stored numbers stored in the databases 125 corresponding to consumer 103. If the gift card is correctly verified, the gift card may be activated and available for financial transactions. If the gift card verification is not successful, consumer 103 may be given another opportunity to successfully enter the correct numbers. If consumer 103 cannot enter the correct numbers, gift card may be kept into a “pending” status wherein another message may be sent to consumer 103 to check whether consumer 103 has received the gift card. Sending of the messages and checking for confirmation of the receipt of the gift card may continue until the gift card has been verified by server 120.

In some embodiments consumer 103 may retrieve a gift card from purchaser 104 directly who has already received an amount of gift cards sent to their address. The gift cards may have no money or a predetermined amount of money placed on the gift card before consumer 103 retrieves the gift card. The last four digits of the card are retained and stored as a unique identifier.

Gift card promotion system 100 allows a first purchaser 104 to contract with a second purchaser 104 to acquire gift cards to purchase items from second purchaser 104. First purchaser 104 may then present a gift card to a consumer 103. Consumer 103 may be an employee of the first purchaser 104 and the gift card presented as an incentive or award to consumer 103. In one example, the first business and the second business may cross purchase gift cards, thus improving efficiency and cost of their businesses. In such an investment, the return on investment is high, as each business can provide to their employees a relatively high valued incentive based on the cost of their own product. In some examples, the employees of the first company and the second company may be connected to each other such as by inter-business activities, events, proximity, etc. thus increasing the perceived value of the gift cards as a gift or incentive.

In other embodiments, gift card promotion system 100 may utilize a rewards system with rewards based on sales, paid purchases, or other evaluations. In one non-limiting embodiment, a point rewards system may be used and upon reaching a predetermined limit, a gift card may be presented to consumer 103 for use at a business, such as business 102. Such a gift may have a higher perceived value than the face value of the gift card, and less cost to the business 101 than the face value of the gift card.

Gift card promotion system 100 may enable users 101 such as business 102 to be presented certain user-specific demographic and customization information that may be used by users 101 to tailor their respective services to specific purchasers 104 or consumers 103. This information may include, for example the number of consumers 103 associated with a list of a purchaser 104 that registered a gift card of business 102 or any businesses that were added to their wish list or purchasers 104 that have bought gift cards for consumers 103. In addition, consumers 103 or purchasers 104 may be automatically sent to businesses 102 upon reaching some threshold of gift cards registered or wish list additions.

For example, business 102 may register to be notified when one-hundred consumers 103 have been bought gift cards by a purchaser 104. The business 102 may then present options in response to this notification to send advertisements to market to those purchasers 104 or may alternatively attempt to cross license with purchaser 104. In a similar fashion, if a first business 102 acting as a purchaser 104 has purchased one hundred gift cards for consumers 103 of a second business and second business 102 acting as a purchaser 104 has purchased one hundred gift cards for consumers 103 of the first business, a notification may be sent to the first business 102 and second business 102 as well as options for cross licensing. Server 120 then may calculate a beneficial cross licensing deal between first business 102 and second business 102, whereby gift cards may cost a fraction of the original price when transactions are conducted between consumers 103 of first business 102 and second business 102. In other embodiments, first business 102 and second business 102 may create a cross-licensing deal on their own without notifications.

User profile page of users 101 may include a selectable button for displaying past transactions, as well as in some embodiments pending transactions, whereby server 120 may retrieve transactional data associated with users 101 whereby server 120 may apply this data to provide a list of past transactions and pending transactions. Users 101 may select the specific user such as consumer 103, purchaser 104, or business 102, from the transaction presented whereby they may be taken to the user profile page of that respective user 101.

Gift card promotion system 100 may generate an invoice that is then transmitted for display to consumer 103, business 102, and in some embodiments purchaser 104 whereby the invoice may be generated utilizing one or more templates for invoices or other contracts stored on databases. Templates may have generated information from associated data retrieved by server 120 such as business 102 information, consumer 103 information, services, description of service, amount for each service, discounts, sales, tax, total price, and any notes. Consumers 103 and business 102 may elect to have an invoice also transmitted to them as a printed receipt, via e-mail, text message, hyperlink, or other type of message. Invoice may be generated at any time during the gift promotion system 100 process such as 30 minutes before or after the financial transaction of a gift card.

Gift card promotion system 100 may also serve as a marketplace to pair consumers 103 who are buyers and sellers of gift cards in their digital wallet. Gift card promotion system may serve as a channel for digital gift cards and enables the transfer of the value of the gift card from a seller to a buyer. User interface 115 may provide option to consumer to put up for sale one or more gift cards in their digital wallet at a specified price (such as 75% the cost of the gift card i.e. 75 dollars for a 100 dollar amazon gift card) wherein the gift cards and their associated value may be presented to other consumers 103 for purchase. Other consumers 103 such as a second consumer 103 may then elect to purchase a gift card wherein funds are deducted from the personal account of second consumer 103 and added to the financial account or digital balance with consumer 103 who has put the gift card up for sale.

Gift card promotion system 100 may have a referral service to incentive users 101 to refer users 101 to businesses 102, or in some embodiments a purchaser 104 or consumer 103 in exchange for monetary compensation from gift card promotion system 100, business 102, or purchaser 104 while also helping the business 102 or employees receive more users 101 by word of mouth. In one or more non limiting embodiments, user 101 may be presented with the option to refer another user 101 whereby user interface 115 may display a search window where user 101 may search for and select one or more other users 101 to receive a referral. In response to the referral by user 101, sever 120 generates a referral and notifies second user 101 of the referral from first user 101 and displays the request on as notification on second user's 101 user interface 115.

If second user 101, receiving incoming referral responds to the notification, second user 101 is presented with an option to add a business to his or her wish list or to purchase gift card whereby if second user 101 adds a business to his or her wish list or to purchase gift card, server 120 generates a notification to business of referral. In one or more non-limiting embodiments, server 120 may transmit a commission to user 101 in the form of funds deposited in their gift card promotion system 100 account, financial account associated with them, or other means known by those of ordinary skill in the art after a completed transaction or transmission of gift card between second user 101 and business 102. In some embodiments, the commission may instead be any type of compensation such as discounts, coupons, tokens, or other deals. The referral is also stored in the databases 125. In further embodiments, user interface 115 may provide an option for second user 101 to select a referring user 101 on a payment screen upon purchase of a gift card or at any time during any process in gift card promotion system 100.

Consumers 103, purchasers 104, and businesses 102 may be presented through user interface 115 with a screen whereby consumers 103, purchasers 103, and businesses 102 may be prompted to rate other users 101 participating in gift card promotion system 100 through a drop down menu of selectable choices such as the numbers 1 through 5 and one or more texts windows to insert information along with the rating with a review whereby this rating and reviews may be displayed on user profile page of the respective user 101. Server 120 may also calculate a community score for consumer 103, purchasers 104, and businesses 102 based on participation and activity through gift card promotion system 100. Community score may also provide further rewards such as discounts, premium physical gift cards or other bonuses. Community score may be presented on user profile page of respective user 101.

In some non-limiting embodiments, server 120 may receive data pertaining to the where consumer 103 is located. Server 120 may send a data request to user computing device 105 of consumer 103, for identifying a geographic location of user computing device 105 or a network location of user computing device 105, as well as a timestamp identifying when the request was transmitted to user computing device 105. The geographic location may be any physical location, which may be expressed in longitudinal and latitudinal coordinates, and may include other dimensions and factors such as altitude or height for determining an exact position of the geographic location.

Server 120 may determine whether consumer 103 is within a predetermined distance of the business from the GPS of user computing device 105 of consumer 103. In a non-limiting embodiment, the distance is 50 yards, but the distance could be greater or less. In other embodiments a third-party location system may also be used instead of the GPS capability of the computing device. If consumer 103 is not within the predefined distance, consumer 103 may be notified by server 120 that they may not use gift card when they are closer to the business 102. If the consumer checks in successfully, consumer 103 is able to use the gift card for a financial transaction with business. In some embodiments consumer 103 must also use the gift card with a predetermined amount of time. This ensure the actual consumer 103 is using the gift card and not a fraudulent third party.

Server 120 may present the location of users 101 such as a consumer 103, purchaser 104, and business 102. The presentation may be in the form of a pop up window displayed to each user 101 or displayed on its own tab. Consumer 103, purchaser 104, and business 102 may also be presented with a geo-spatial environment having a virtual map of the geographical location in which users 101 are located. The virtual map may have geography and topography, which parallels the geography and topography of the physical real world. For instance, a range of longitudinal and latitudinal coordinates defining a geographic area or space in the real world may be mapped to a corresponding range of longitudinal and latitudinal coordinates defining a virtual space on the virtual map as well as each individual coordinate in the range. The graphical map may be displayed to with consumer 103, purchaser 104, and business 102 displayed as markers, pins, or identifiers at their respective locations.

In some embodiments, users 101 such as purchaser 104 and business 102 may be presented with a searchable map through user interface 115 whereby a user 101 such as purchaser 104 may select a location they wish to leave a marker for a user 101 such as a consumer 103 to interact with and if consumer 103 does interact, he or she may receive a gift card or other form of promotion. In other embodiments, these markers may be created by gift promotion card system 100 or placed by other consumers 103 or business 101. When initiating a session to locate markers left by purchasers 104, consumer 103 may be presented with a geo-spatial environment having a virtual map of the geographical location in which consumer 103 is positioned wherein consumer 103 may be presented with the markers at their corresponding real world geographic coordinates.

While receiving data pertaining the specific location of consumer 103, server may analyze consumer's 103 position as consumer 103 navigates the range of geographic coordinates in the real world such as when consumer 103 moves throughout the city. Consumer 103 may also view videos, photos, or other files on map that have already been added by purchaser 104, business 102 or another consumer 103 as markers overlaid on the map. Markers may vary with the display region and zoom level of the map or are independent of the characteristics of the map. Consumer 103 may also share comments and opinions about businesses 102 that are visible and searchable on the map whereby these comments may be linked to consumer's 103 profile or may be posted anonymously.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A computer implemented method for promoting local businesses using a gift card promotion system, the method comprising:
storing, user data for one or more consumers, comprising a name identifier and one or more gift card preferences, whereby the gift card preferences correspond to one or more gift cards, wherein the user data is stored by one or more computing devices that include one or more programs containing instructions associated with the gift card promotion system;
presenting a user interface to a purchaser on the one or more computing devices, wherein the user interface comprises at least one list of gift card preferences of the one or more consumers;
requesting, from the purchaser to purchase a gift card in response to being presented with the at least one list of gift card preferences from the one or more consumers;
using the received request, including the amount of the gift card, to transfer funds from an account of the purchaser to an account of the one or more consumers;
collecting transactional data, including the amount of the gift card, a business associated with the gift card, and the location of the business;
associating the transactional data with the user data of the one or more consumers;
storing the transactional data; and
notifying the one or more consumers that the gift card has been purchased by the purchaser.

2. The method of claim 1, further comprising, requesting the purchaser to purchase one or more gift cards for multiple consumers at the same time.

3. The method of claim 2, further comprising:
determining a value of the one or more gift cards from the purchaser to the one or more consumers;
storing the value of the one or more gift cards in a digital gift card wallet associated with the gift card promotion system;
performing a first financial transaction corresponding to a first issuer of the gift card; and
subtracting the value of the first financial transaction from the value associated with the gift card in the digital gift card wallet.

4. The method of claim 2, further comprising:
receiving a physical gift card, the physical gift card having identifying information pertaining to the purchaser;
storing the value of the one or more gift cards on the physical gift card;
performing a first financial transaction corresponding to a first issuer of the gift card; and
subtracting the value of the first financial transaction from the gift card.

5. The method of claim 1, further comprising:
requesting the one or more consumers be associated with a list associated with the purchaser, wherein once the request is accepted by the one or more consumers, presenting the one or more consumers on the list associated with the purchaser.

6. The method of claim 2, further comprising:
presenting a search mechanism for accessing the list of the one or more consumers, the search mechanism having a filtering mechanism for filtering through gift card amounts, businesses, and locations.

7. The method of claim 1, wherein the gift card promotion system further comprises user data of the location of the one or more consumers.

8. The method of claim 3, further comprising, verifying that the one or more consumers are located within a predetermined distance from the business.

9. The method of claim 8, further comprising, allowing the one or more consumers to use the gift card when the one or more consumers are verified to be within the predetermined distance from the business, adding a transaction restriction to prohibit the one or more consumers users from using the gift card when the one or more consumers are not verified to be located within the predetermined distance from the business.

10. The method of claim 1, further comprising, sending an invoice to the one or more consumers and the business detailing at least one value deducted from the one or more gift cards incurred by the one or more consumers.

11. The method of claim 1, further comprising, generating reports that include consumer data and transaction data.

12. The method of claim 1, further comprising:
generating a notification to a business when an action occurs for the business based on the amount of the one or more gift cards and presenting information about the purchaser to the business.

13. The method of claim 10, further comprising:
generating a notification to a first purchaser when an action occurs for the first purchaser based on the amount of the one or more gift cards purchased by a second purchaser; and
generating a notification to the second purchaser when an action occurs for the second purchaser user based on the amount of the one or more gift cards purchased by the first purchaser; and
presenting a cross licensing agreement, the cross licensing agreement providing gift cards at discounted rates to the first purchaser and to the second purchaser.

14. The method of claim 1, further comprising:
generating one or more interactive markers; and
presenting a user interface to the one or more consumers on the one or more computing devices, wherein the user interface displays the location of the consumer user overlaid on a virtual map corresponding to their real world location along with the one or more interactive markers.

15. A gift card promotion system comprising:
one or more databases coupled via a network;
one or more processors coupled to the one or more databases; and
at least one computing device coupled to the one or more processors and the one or more databases via the network;
wherein the one or more processors are configured to:
store user data for one or more consumers, comprising a name identifier and one or more gift card preferences, the one or more gift card preferences corresponding to one or more gift cards;
present to a purchaser on a computing device, wherein the user interface comprises at least one list of the one or more gift card preferences of the one or more consumers;
requesting from the purchaser to purchase a gift card in response to receiving the one or more gift card preferences from the one or more consumers;
use the received request, including the amount of the gift card to transfer funds from an account of the purchaser to an account of the one or more consumers;
collect transactional data, including an amount of the gift card, the business of the gift card, and the location of the business;
associate by the gift card promotion system, the transactional data with the user data of the one or more consumers; and
notify the one or more consumers that the gift card has been purchased by the purchaser.

16. The gift card promotion system of claim 15, wherein the processors are further configured to;
verify that the one or more consumers, the purchaser, or the business live or reside at a residence associated with a geographic location claimed by the one or more consumers, the purchaser, or the business;
create a location based on a social network of the one or more consumers, the purchaser, or the business to enable the one or more consumers, the purchaser, or the business to be constrained to interactions with other consumers, purchasers, or businesses within a geospatial vicinity of the residence of the one or more consumers, the purchaser, or the business based on a geographic boundary; and
provide an additional privilege to the one or more consumers, the purchaser, or the business in the location based social network based on at least one of a participation level or activity level of the one or more consumers, the purchaser, or the business.

17. The gift card promotion system of claim 16, wherein the processors are further configured to:
determine a value of the one or more gift cards from the purchaser to the one or more consumers;
store the value of the one or more gift cards in a digital gift card wallet;
perform a first financial transaction corresponding to a first issuer of the gift card on the digital gift card wallet; and
subtract, the value of the first financial transaction from the value of the one or more gift cards in the digital card wallet.

18. The gift card promotion system of claim 16, wherein the processors are further configured to:
receive a physical gift card, the physical gift card having identifying information pertaining to the purchaser;
store the value of the one or more gift cards on the physical gift card;
perform a first financial transaction corresponding to a first issuer of the gift card on the physical gift card; and
subtract the value of the first financial transaction from the value of the physical gift card.

19. The gift card promotion system of claim 16, wherein the processors are further configured to:
receive at least one communication indicating that a particular consumer or purchaser of a location based social network referred a business to a second purchaser or second consumer;
confirm, a particular referring consumer or purchaser indicated in said at least one communication as having referred the business to the second consumer or the second purchaser;
determine, a referral commission; and
pay a referral commission to at least the particular identified referring consumer or purchaser.

20. The gift card promotion system of claim 16, wherein the processors are further configured to:
receive at least one communication indicating a particular consumer or purchaser of the location based social network having rated a business;
confirm a particular consumer or purchaser indicated in said at least one communication as having rated the business;
calculate an overall rating by determining the average of the rating when combined with existing ratings of the business; and
present the overall rating of the business.
